(19) United States
(12) Patent Application Publication
(10) Pub. No.: US 2010/0191896 A1
(43) Pub. Date: Jul. 29, 2010

(54) Solid state drive controller with fast NVRAM buffer and non-volatile tables

(75) Inventors: Hsu Kai Yang, Pleasanton, CA (US); Po-Kang Wang, Los Altos, CA (US); Takuma Murai, Santa Clara, CA (US); Takehiro Kamigama, Tokyo (JP)

Correspondence Address: SAILE ACKERMAN LLC, 28 DAVIS AVENUE, POUGHKEEPSIE, NY, 12603, US

(73) Assignee: MagIC Technologies, Inc.

(21) Appl. No.: 12/321,663

(22) Filed: Jan. 23, 2009

(51) Int. Cl. G06F 12/02; G06F 12/00; G06F 12/08

(52) U.S. Cl. 711/103; 711/118; 711/E12.001; 711/E12.008; 711/E12.017

(57) ABSTRACT

Systems and methods for a SSD controller enabling data transfer between a host and flash memories have been achieved. A major component of the SSD controller is a non-volatile buffer memory, which interfaces fast disk drive protocols and slow write and read cycles of NAND flash. Preferably MRAM or Phase Change RAM can be used for the buffer memory. Non-volatile tables can also be implemented for storing dynamic logical to physical address translation, defective sector information and their spare sectors and/or SSD configuration parameters. data are kept in a buffer memory when the buffer memory is not powered

### BACKGROUND OF THE INVENTION

(1) Field of the Invention

This invention relates generally to an electronic memory controller and relates more specifically to a Solid State Drive controller controlling data transfer between a host and flash memory using non-volatile RAM (NVRAM) for buffer memory.

(2) Description of the Prior Art

As flash memory density gets higher and cost lower, Solid State Drive (SSD) becomes more widely used. A major component in a SSD controller is a buffer memory, which interfaces fast disk drive protocols and slow write and read cycles of NAND flash memory. In prior art volatile RAM, e.g. Static Random Access Memory (SRAM) is used for such a buffer memory as disclosed by Lee et al. U.S. Patent Application Publication U.S. 2007/0106836.

FIG. 1 prior art shows a typical prior art SSD controller comprising CPU 100, a CPU bus 101, a disk interface 102, a volatile SRAM cache memory 103, a first-in-first-out buffer (FIFO) 104, a flash interface 105, clock generators 106, and flash memories 107.

A major disadvantage of the prior art implementations of a SSD controller is that data in the buffer is lost when the memory is not powered. It is a challenge for the designers of such systems to overcome this disadvantage.

There are patents or patent publications known dealing with Solid State Drive controllers:

U.S. Patent Application Publication (U.S. 2008/0126682 to Zhao et al.) proposes a solid state disk with multi flash controller channels, which is small in size, light in weight, low in power consumption and has no operating noise. In one embodiment, a flash memory based storage device comprises a hard disk protocol unit, a flash hard disk controller circuit and flash memories. The flash hard disk controller includes a protocol module, buffers, a logical circuit, a CPU, a controller interface and flash controllers. The CPU manages as many flashes as it can through multi flash controller channels. Each flash controller connects with a flash memory group and communicates with buffers and the CPU by SD/MMC/MS interface or a self-defined interface. The flash memory based storage device meets the specification specifically defined for a traditional hard disk, and communicates with a host by hard disk standard protocols and can reach or outperform the required performance.

U.S. Patent Application Publication (U.S. 2008/0059694 to Lee) discloses a hybrid hard disk drive including a hard disk drive controller to receive a plurality of write commands from a host, a buffer to receive and store write data, which are input through the hard disk drive controller and correspond to each of the plurality of write commands, a command history tracker to receive the plurality of write commands and analyze a pattern of the plurality of write commands, and a CPU to control storage of the write data, which correspond to each of the plurality of write commands, on a disk or in a flash memory device based on the analysis result by the command history tracker. The drive may determine whether to store write data on the disk or in the flash memory device without operation system support.

U.S. patent (U.S. Pat. No. 6,016,530 to Auclair et al.) discloses a solid-state flash electrically erasable and programmable read-only-memory (“flash EEPROM”) system combined with a rotating disk drive memory to provide mass program and data storage in a computer system. A common memory controller directs system generated memory addresses in a disk format to either the EEPROM system or disk memory. The blocks of data handled by the EEPROM system have the same size and other attributes as sectors of data handled by the disk system, thereby making it transparent to the computer system processor as to whether it is accessing the EEPROM or disk portion of the storage system. A particular program or data file may then be stored in the portion of the memory system best suited to handle it, and thus take advantage of the different features and characteristics of EEPROM and magnetic media disk memory.

### SUMMARY OF THE INVENTION

A principal object of the present invention is to achieve a Solid State drive controller supporting data transfer been a host and flash memories.

A further object of the present invention is that data are kept in a buffer memory when the buffer memory is not powered

A further object of the present invention is to implement non-volatile tables holding information about address translation, defective sector information and/or SSD configuration parameters.

In accordance with the objects of this invention a method to achieve a SSD controller supporting data transfer between a host and flash memory wherein data are kept in a buffer memory when the buffer memory is not powered has been achieved. The method invented comprises the steps of (1) providing a SSD controller comprising a CPU, a CPU bus, a disk interface, a NVRAM cache buffer, a first-in-first-out buffer (FIFO), and a flash interface, (2) implementing in said CPU NVRAM control code, (3) implementing said NVRAM for buffer cache memory, and (4) operating said SSD.

In accordance with the objects of this invention a system for a SSD controller supporting data transfer between a host and flash memory, wherein data are kept in a buffer memory when the buffer memory is not powered, has been achieved. The system invented comprises, first, a CPU, a CPU bus, connected to the CPU, a disk interface, a NVRAM cache buffer memory, a first-in-first out buffer, clock generators, and a flash interface, and said disk interface, supporting disk protocols, connected to said NVRAM cache buffer memory. The key component of the invention is said NVRAM buffer cache memory, connected to said first-in-first-out buffer. Furthermore the system invented comprises said first-in-first-out buffer, connected to a flash interface, said flash interface, and said clock generators, connected to said CPU bus, said disk interface, said NVRAM cache buffer, said first-in-first-out buffer (FIFO), and to said flash interface.

### BRIEF DESCRIPTION OF THE DRAWINGS

In the accompanying drawings forming a material part of this description, there is shown:

FIG. 1 prior art illustrates a block diagram of a SSD controller.

FIG. 2 shows a block diagram of a SSD controller of the present invention

FIG. 3 illustrates a flowchart of a method invented to achieve a SSD controller supporting data transfer between a host and flash memory wherein data are kept in a buffer memory when the buffer memory is not powered.

### DESCRIPTION OF THE PREFERRED EMBODIMENTS

The preferred embodiments disclose a Solid State Drive controller having a significantly improved performance by using for a buffer memory fast non-volatile memories, such as MRAM or Phase Change RAM.

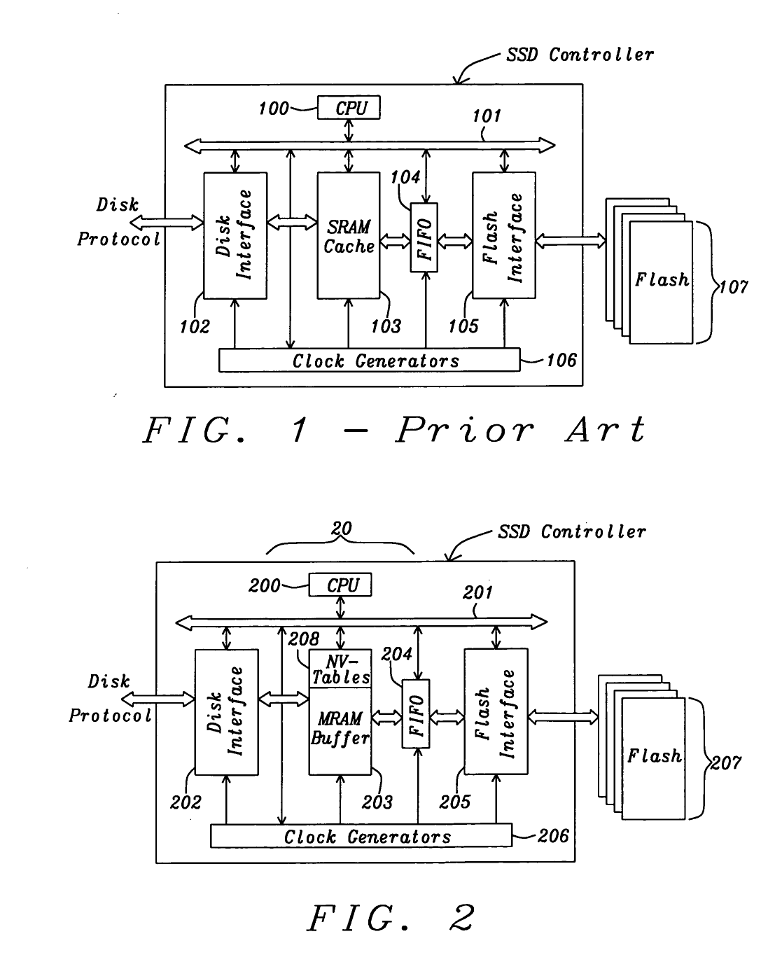

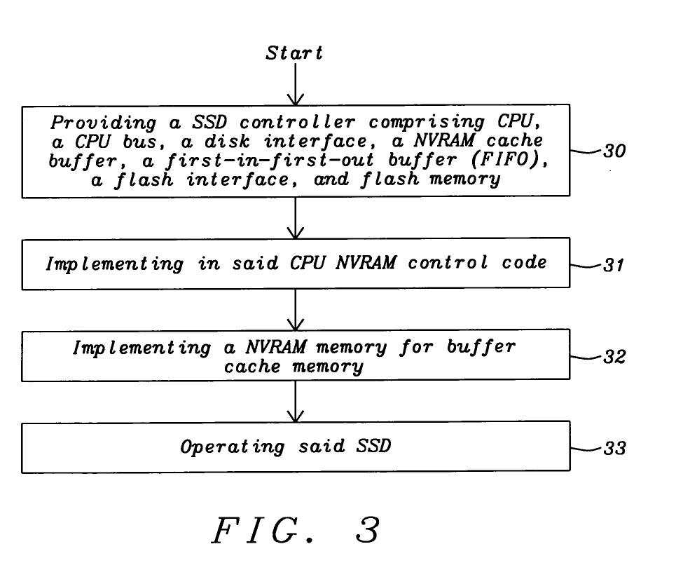

FIG. 2 shows a block diagram of a preferred embodiment of a SSD controller of the present invention. The SSD controller 20 serves the functions of taking care of the speed and protocol differences between the host and flash memories comprising a CPU 200, a CPU bus 201, a disk interface 202, a non-volatile MRAM cache buffer memory 203 with non-volatile tables 208, a first-in-first-out buffer (FIFO) 204, a flash interface 205, clock generators 206, and flash memories 207.

The disk interface 202 supports the data transfer to and from a host with disk drive protocols, such as ATA, SATA, SCSI, etc The data transferred are buffered in an MRAM cache buffer 203. Alternatively other fast non-volatile memories as e.g. Phase-Change RAM could be used instead of MRAM.

Replacing the SRAM cache buffer of prior art with an MRAM buffer having non-volatile tables as shown in FIG. 2 will significantly improve a SSD controller because data in the buffer will not be lost when the buffer memory is not powered. MRAM Read and Write speeds are comparable to SRAM and is also non-volatile with almost infinite endurance.

Non-volatile tables, i.e. stored in a non-volatile RAM (NVRAM), can also be implemented using MRAM memory or other fast non-volatile memory, such as Phase Change RAM. Such tables can store the dynamic logical or physical address translation to improve endurance of the flash memory and/or defective sector information and spare sectors and/or SSD configuration parameters.

FIG. 3 illustrates a flowchart of a method invented to achieve a SSD controller supporting data transfer between a host and flash memory wherein data are kept in a buffer memory when the buffer memory is not powered.

Step 30 of the method of FIG. 3 illustrates the provision of a SSD controller comprising CPU, a CPU bus, a disk interface, a NVRAM cache buffer, a first-in-first-out buffer (FIFO), a flash interface, and flash memory. Step 31 describes an implementation of NVRAM control code in said CPU and step 32 shows the implementation of said NVRAM memory for a buffer cache memory. Step 33 describes that the SSD is ready for operation being capable keeping transfer data in the buffer memory when the buffer memory is not powered.

While the invention has been particularly shown and described with reference to the preferred embodiments thereof, it will be understood by those skilled in the art that various changes in form and details may be made without departing from the spirit and scope of the invention.

What is claimed is:

1. A system to achieve a SSD controller supporting data transfer between a host and flash memory wherein data are kept in a buffer memory when the buffer memory is not powered comprising::
a CPU;
a CPU bus, connected to the CPU, a disk interface, a NVRAM cache buffer memory, a first-in-first out buffer, clock generators, and a flash interface;
said disk interface, supporting disk protocols, connected to said NVRAM cache buffer memory;
said NVRAM buffer cache memory, connected to said first-in-first-out buffer;
said first-in-first-out buffer, connected to a flash interface;
said flash interface; and
said clock generators, connected to said CPU bus, said disk interface, said NVRAM cache buffer, said first-in-first-out buffer (FIFO), and to said flash interface.

2. The system of claim 1 wherein said NVRAM buffer is a MRAM.

3. The system of claim 1 wherein said NVRAM buffer is a Phase Change RAM.

4. The system of claim 1 comprising at least one NVRAM table.

5. The system of claim 4 wherein said at least one NVRAM table is stored in a MRAM.

6. The system of claim 4 wherein said at least one NVRAM table is stored in a Phase Change RAM.

7. The system of claim 4 wherein logical to physical address translations are stored in one of said at least one NVRAM tables.

8. The system of claim 4 wherein defective sectors of Flash memory and their replacements are stored in one of said at least one NVRAM tables.

9. The system of claim 4 wherein SSD configuration parameters are stored in one of said at least one NVRAM tables.

10. A method to achieve a SSD controller supporting data transfer between a host and flash memory wherein data are kept in a buffer memory when the buffer memory is not powered comprising the steps of:
(1) providing a SSD controller comprising a CPU, a CPU bus, a disk interface, a NVRAM cache buffer, a first-in-first-out buffer (FIFO), and a flash interface;
(2) implementing in said CPU NVRAM control code;
(3) implementing said NVRAM for buffer cache memory; and
(4) operating said SSD.

11. The method of claim 10 wherein said NVRAM buffer is a MRAM.

12. The method of claim 10 wherein said NVRAM buffer is a Phase Change RAM.

13. The method of claim 10 wherein said SSD comprises at least one NVRAM table.

14. The method of claim 13 wherein logical to physical address translations are stored in one of said at least one NVRAM tables.

15. The method of claim 13 wherein defective sectors of Flash memory and their replacements are stored in one of said at least one NVRAM tables.

16. The method of claim 13 wherein SSD configuration parameters are stored in one of said at least one NVRAM tables.
